(19) United States
(12) Patent Application Publication
(10) Pub. No.: US 2008/0237519 A1
(43) Pub. Date: Oct. 2, 2008

(54) Terminal structure of coil system

(75) Inventor: Kouichi Sugiyama, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/078,105

(22) Filed: Mar. 27, 2008

(30) Foreign Application Priority Data
Mar. 30, 2007 (JP) 2007-94706

(51) Int. Cl. F16K 31/02

(52) U.S. Cl. 251/129.15

(57) ABSTRACT

A terminal structure of a coil system includes a coil and a terminal having a fusing portion. The coil includes a rectangular conductive wire covered with a dielectric film, and a bobbin around which the conductive wire is wound. The conductive wire includes a coil lead wire taken out from the coil. The fusing portion is connected electrically by fusing to an end portion of the lead wire, and includes a first planar portion contacting a surface of the end portion. The fusing portion is folded from the first planar portion in a thickness direction of the first planar portion to form a folded piece having a second planar portion and opposed to the first planar portion. The end portion is placed between the first and second planar portions such that a predetermined crushing allowance of the end portion is crushed entirely in a width direction of the end portion.

CROSS REFERENCE TO RELATED APPLICATION

This application is based on and incorporates herein by reference Japanese Patent Application No. 2007-94706 filed on Mar. 30, 2007.

### BACKGROUND OF THE INVENTION

1. Field of the Invention

The present invention relates to a terminal structure of a coil system having a coil terminal electrically connected by fusing with an end of a coil lead wire picked out from a coil formed by winding a rectangular conductive wire around a bobbin.

2. Description of Related Art

As shown in FIGS. 5A to 5D, a coil system (coil component) integrated into the valve drive unit which drives a valve element (valve) of a fuel injection valve (injector) conventionally includes a coil 102 formed as a result of winding multiple-times a copper wire (round conductive wire) having a round cross-sectional surface, which is made by covering a peripheral surface of a core wire made of copper or a copper alloy with a dielectric film, around between a pair of collar-like parts of a bobbin 101, and a pair of terminals 104 connected to a corresponding pair of coil lead wires 103 picked out from the coil 102 with the wires 103 entwined round the terminals 104

As a method of connecting an end (hereinafter referred to as a lead wire end) 105 of the coil lead wire 103 and a fusing part 106 having a U-shaped cross sectional surface character of a terminal 104, fusing joining is generally employed (see e.g., JP2006-226263A corresponding to US2006/0186365A1, and JP2817491B2).

The fusing joining is a terminal connection method, whereby continuity (electric connection) of the lead wire end 105 of the coil lead wire 103 and the fusing part 106 of a terminal 104 is achieved. The electric continuity is achieved in the following manner. After inserting a lead wire end 105 between a planar part 107 of the fusing part 106 formed at a coil-side end portion of the terminal 104 and a folded piece 109 bent over with an end of the planar part 107 as the starting point, the folded piece 109 is calked using a punch. Then, a pair of fusing electrodes is attached on both sides of the whole fusing part 106 in its thickness direction and the fusing electrodes are energized with the fusing part 106 pressurized. Accordingly, the dielectric film given to the lead wire end 105 is exfoliated (burnt), so that the electric continuity is achieved.

In the coil system (coil component) integrated into the valve drive unit, water proof and rust prevention of the joint part of the lead wire end 105 of the coil lead wire 103 and the fusing part 106 of the terminal 104 are performed. The above water proof and rust prevention are carried out by treating a connection part of the lead wire end 105 and the fusing part 106 with molding with dielectric resin after carrying out fusing joining of the lead wire end 105 and the fusing part 106. In recent years, downsizing of the coil system and improvement in a magnetic property (magnetic efficiency) are required. Accordingly, a rectangular conductive wire having a square cross-sectional surface is wound around the outer circumference of a bobbin to form a coil, and winding wire effectiveness of the coil is conventionally improved by increasing a space factor of a conductor (rectangular conductive wire) in a coil receiving space formed between a pair of collar-like parts of the bobbin.

However, the conventionally performed fusing joining technique of the lead wire end 105 and the fusing part 106 which have been performed is aimed at a round conductive wire. When fusing joining the fusing part 106 and a lead wire end 111 (FIGS. 6A, 6B) of the rectangular-shaped coil lead wire picked out from the coil, reliable stable fusing joining has not been performed with respect to securing of energization and environmental-conditions such as a cold and hot cycle.

As shown in FIGS. 5C, 5D, the lead wire end 105 having a round cross sectional surface is placed inside an inner diameter of a bent part 112 having a curvature radius R and connecting a planar part 107 and a folded piece 109 of the fusing part 106, with the lead wire end 105 crushed by its predetermined crushing allowance. On the other hand, as shown in FIGS. 6A, 6B, the inner diameter of the bent part 112 having a curvature radius R and connecting the planar part 107 and the folded piece 109 is larger than a thickness of the lead wire end 111 having a square cross-sectional surface. Accordingly, even though the lead wire end 111 is placed between the planar part 107 and the folded piece 109, the predetermined crushing allowance cannot be obtained over the whole width (length) of the lead wire end 111, which is perpendicular to a width direction (up-down direction in FIGS. 6A, 6B) of the lead wire end 111.

More specifically, since the thickness of the lead wire end 111 made of a rectangular conductive wire having a square cross-sectional shape, that is, a fusing surface thickness is extremely small from the start, when the lead wire end 111 is put between the planar part 107 and the folded piece 109 with a shape of the fusing part 106 of the conventional terminal 104 maintained, a clearance is formed between the folded piece 109 and the lead wire end 111. Thus, the predetermined crushing allowance is difficult to obtain over the whole width (length) of the lead wire end 111.

In the case of the conventional terminal structure electrically connected by fusing with the lead wire end 111 having a square cross-sectional surface shown in FIGS. 6A, 6B, the connection between the lead wire end 111 of the coil lead wire and the folded piece 109 of the fusing part 106 becomes local and thereby a joint surface area of the lead wire end 111 and the folded piece 109 is small. Accordingly, the fusing joining between the lead wire end 111 and the fusing part 106 of the terminal 104 is made imperfect. For this reason, a faulty connection is made between the lead wire end 111 and the fusing part 106, so that stable fusing joining cannot be performed. As a result, there is a problem of spoiling reliability over the continuity (electrical connection state) in a connection part (fusing connection) of the coil lead wire and the terminal 104.

Moreover, in the case where the lead wire end 111 of the coil lead wire and the fusing part 106 of the terminal 104 are received in dielectric mold resin, the contact portion between the terminal 104 and the mold resin may exfoliate if a temperature change, that is, a cold and hot cycle is repeated, because of different coefficients of linear expansion of the terminal 104 made of metal and mold resin made of resin. When the contact portion of the terminal 104 and the mold resin exfoliates, a stress concentrates on the perimeter of the exfoliation portion, and thereby a crack which is a dielectric lacking part is easily generated in the mold resin. In addition, when the crack is generated, the lead wire end 111 easily disengages from the fusing part 106.

### SUMMARY OF THE INVENTION

The present invention addresses the above disadvantages. Thus, it is an objective of the present invention to provide a terminal structure of a coil system, which improves reliability over electric continuity in a connection part of a terminal and a coil lead wire made of a rectangular conductive wire having a quadrangular cross-sectional surface covered with a dielectric film. In addition, it is another objective of the present invention to provide the terminal structure of the coil system, which improves a degree of prevention of the separation of the rectangular conductive wire from a fusing part.

To achieve the objective of the present invention, there is provided a terminal structure of a coil system including a coil and a terminal. The coil includes a rectangular conductive wire having a quadrangular cross-sectional surface and covered with a dielectric film, and a bobbin, around which the rectangular conductive wire is wound. The rectangular conductive wire includes a coil lead wire, which is taken out from the coil. The terminal has a fusing portion, which is electrically connected by fusing to an end portion of the coil lead wire. The fusing portion includes a first planar portion having a plate-like shape and in contact with a surface of the end portion of the coil lead wire. The fusing portion is folded from the first planar portion in a thickness direction of the first planar portion so as to form a folded piece opposed to the first planar portion. The folded piece has a second planar portion. The end portion of the coil lead wire is placed between the first planar portion and the second planar portion such that a predetermined crushing allowance of the end portion is crushed entirely in a width direction of the end portion.

### BRIEF DESCRIPTION OF THE DRAWINGS

The invention, together with additional objectives, features and advantages thereof, will be best understood from the following description, the appended claims and the accompanying drawings in which:

FIG. 1A is a plan view illustrating a terminal structure of a coil system according to an embodiment of the invention;

FIG. 1B is a plan view illustrating a fusing part of the terminal structure according to the embodiment;

FIG. 1C is a cross-sectional view taken along a line ID-ID in FIG. 1B;

FIG. 1D is a cross-sectional view taken along the line ID-ID in FIG. 1B;

FIG. 2 is a sectional view illustrating an injector according to the embodiment;

FIG. 3A is an explanatory view illustrating a fusing process of a coil lead wire according to the embodiment;

FIG. 3B is an explanatory view illustrating the fusing process of the coil lead wire according to the embodiment;

FIG. 3C is an explanatory view illustrating the fusing process of the coil lead wire according to the embodiment;

FIG. 4A is a plan view viewed from a direction of X in FIG. 3A;

FIG. 4B is a plan view viewed from the direction of X in FIG. 3A;

FIG. 5A is a plan view illustrating a terminal structure of a previously proposed coil system;

FIG. 5B is a plan view illustrating a fusing part of the terminal structure of the previously proposed coil system;

FIG. 5C is a cross-sectional view taken along a line VD-VD in FIG. 5B;

FIG. 5D is a cross-sectional view taken along the line VD-VD in FIG. 5B;

FIG. 6A is an explanatory view illustrating a fusing process of a coil lead wire of the previously proposed coil system; and

FIG. 6B is an explanatory view illustrating the fusing process of the coil lead wire of the previously proposed coil system.

### DETAILED DESCRIPTION OF THE INVENTION

An embodiment of the invention achieves an objective of improving reliability over electric continuity in a connection part of a terminal and a coil lead wire made of a rectangular conductive wire having a quadrangular cross-sectional surface covered with a dielectric film, and an objective of improving a degree of prevention of the separation of the rectangular conductive wire from a fusing part by providing a second planar part on a folded piece of the fusing part of the terminal. An end of the coil lead wire is placed between the second planar part and a first planar part to obtain a predetermined crushing allowance over the entire width of the end of the coil lead wire.

### Structure of the Embodiment

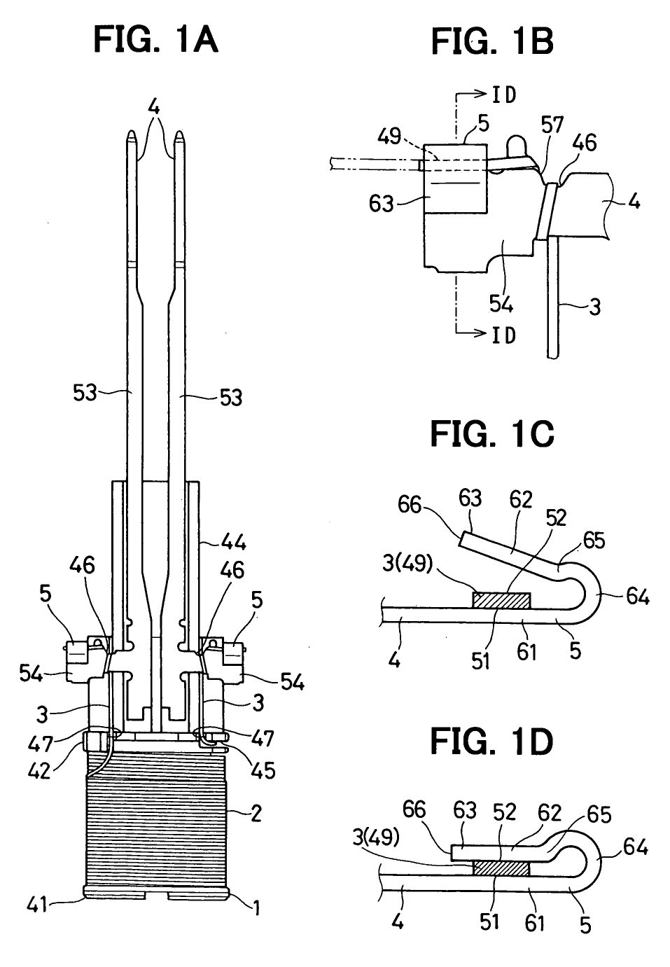

FIGS. 1A to 4B show the embodiment of the invention. A control unit (engine control system) of an internal combustion engine of the present embodiment is used as a fuel injection system (fuel injection system of the internal combustion engine) which injects fuel into an intake port of each cylinder of the internal combustion engine (e.g., a four-cylinder gasoline engine: hereinafter referred to as an engine) installed in an engine room of, for example, an automobile. The fuel injection system includes an electric fuel pump, a delivery pipe, and an injector (electromagnetic fuel injection valve, fluid-controlled valve). The electric fuel pump pressurizes and discharges fuel pumped up from a fuel tank, and carries out discharge. The delivery pipe stores temporarily high pressure fuel discharged from the electric fuel pump. The injector injects high pressure fuel distributed and supplied by the delivery pipe into the intake port of each cylinder of the engine with the optimal timing. In addition, the injector is attached to a cylinder head of intake manifold (inlet pipe) of the engine.

The injector has a terminal structure of a coil system including a rectangular coil (hereinafter referred to as a coil) 2, a pair of coil terminals 4, and a mold resin (housing) 6. The coil 2 is formed as a result of winding multiple-times a rectangular conductive wire having a quadrangular cross-sectional surface (square cross section or rectangular cross section) around a bobbin 1. The rectangular conductive wire is formed as a result of covering a peripheral surface of a conductive core wire having a quadrangular cross-sectional surface formed from copper or a copper alloy with a dielectric film having a quadrangular tubular cross-sectional surface. The pair of coil terminals 4 performs fusing bonding on a pair of coil lead wires 3 picked out from the coil 2. The mold resin 6 covers and protects connection portions between ends of the pair of coil lead wires 3 and fusing parts 5 of the pair of coil terminals 4.

The pair of coil lead wires 3 is pulled out from an initial winding end segment of the coil 2, and includes the coil lead wire 3 on a negative electrode side and the coil lead wire 3 on a positive electrode side. The coil lead wire 3 on the negative electrode side is electrically connected to the fusing part 5 of the coil terminal 4 on a GND side (right-hand side in FIG. 1A) by fusing. The coil lead wire 3 on the positive electrode side is pulled out from a terminal winding end segment of the coil 2, and is electrically connected to the fusing part 5 of the coil terminal 4 on an external power-side or on an injector drive circuit-side (left-hand side in FIG. 1A) by fusing. The pair of coil lead wires 3 is made of a rectangular conductive wire having a quadrangular cross-sectional surface covered with a dielectric film, similar to the coil part of the coil 2.

In addition, the bobbin 1, the coil 2, the par of coil lead wires 3, the pair of coil terminals 4, and the mold resin 6, which constitute the coil system of the injector, are described in greater detail hereinafter.

The injector includes cylindrical magnetic pipes 11, 12 and a nonmagnetic pipe 13, which are supported by and fixed to an inner circumference side of mold resin 6, and a valve body 14 disposed on an inner circumference side of the magnetic pipe 12, a needle 15 received in the valve body 14 to be able to reciprocate in its center axis line direction, and a valve drive unit (electromagnetic actuator) which drives the needle 15.

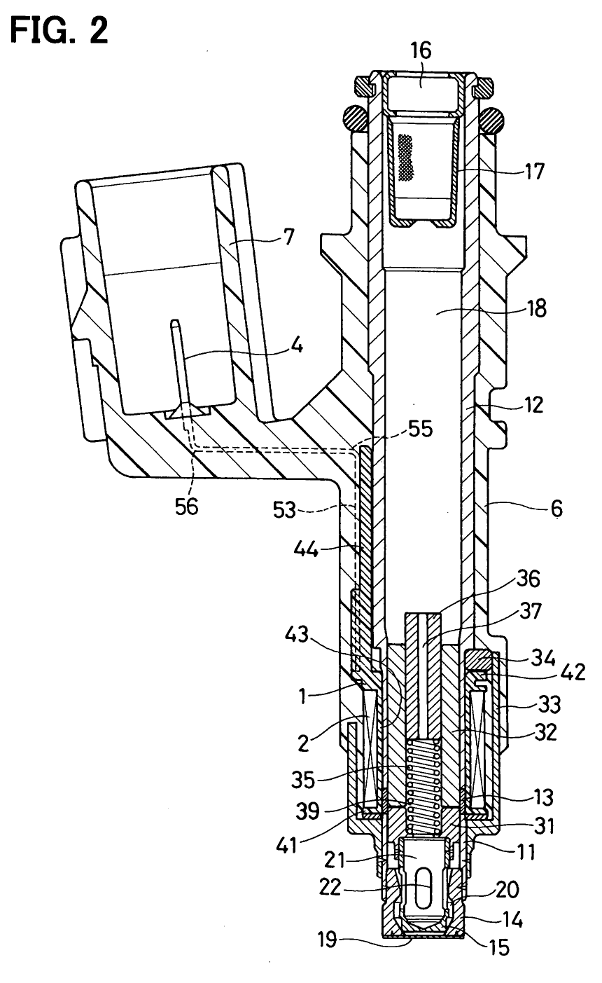

The valve body 14 is supported by and fixed to an inner circumference side of the magnetic pipe 11 by welding or the like. An opening which opens on an upper end side of the magnetic pipe 12 in FIG. 2 functions as a fuel inlet 16 for introducing fuel into the injector. Fuel is supplied into the fuel inlet 16 through an electric fuel pump. Fuel supplied to the fuel inlet 16 flows into a fuel passage (shaft-orientations hole) 18 in the magnetic pipe 12 via a fuel filter 17. The fuel filter 17 is disposed on the inner circumference side of the magnetic pipe 12 near an open end thereof for removing a foreign object contained in fuel. The nonmagnetic pipe 13 prevents a magnetic short circuit of the magnetic pipe 11 and the magnetic pipe 12.

A valve body 14 is formed in a cylindrical shape, and has a valve seat on its conically-shaped inner wall surface having an inside diameter which becomes smaller toward an end of the inner wall surface. The valve body 14 has a nozzle hole plate 19 at its end portion on an opposite side of a magnetic pipe-side. The nozzle hole plate 19 is supported by and fixed to an end surface of the valve body 14 by welding or the like. The nozzle hole plate 19 has a plurality of nozzle holes (orifice: not shown) through which its end surface on a valve body-side and that on an opposite side of the valve body-side communicate. These nozzle holes control a direction of sprayed fuel and promote atomization of sprayed fuel. The plurality of nozzle holes is arranged on an imaginary line of a single circle centering on a central axis of the injector (Nozzle hole plate 19).

The needle 15 is a valve element (valve) of the injector and has a sealing part, which engages the valve seat of the valve body 14, at its end portion on a nozzle hole plate-side. The needle 15 defines a fuel passage 20 through which fuel flows between the needle 15 and an inner circumferential surface of the valve body 14. In the injector of the present embodiment, when the sealing part of the needle 15 disengages from the valve seat, the fuel passage 20 and the plurality of nozzle holes communicate. The needle 15 blocks the fuel passage 20 by engaging the valve seat of the valve body 14, and opens the fuel passage 20 by disengaging from the valve seat. Moreover, the needle 15 is formed in a cylindrical shape. The needle 15 defines a fuel passage 21 therein. The needle 15 has a fuel hole 22 through which the fuel passage 21 and the fuel passage 20 communicate. In addition, the needle 15 is not limited to having a cylindrical shape but may have a solid columnar shape.

The valve drive unit has an electromagnet including a coil 2, and a moving core 31 attracted to the electromagnet. The electromagnet has the coil system (a coil component and a coil assembly), a stator core 32, a yoke 33, and a magnetic member 34 having a C-shaped cross-sectional surface. Among these, the stator core 32, the yoke 33, and the magnetic member 34 are magnetized when driving power is supplied to the coil 2 and thereby serve as an electromagnet. The stator core 32 has an attracting part (pole face of the electromagnet) for attracting the moving core 31.

The moving core 31 is integrally formed from a magnetic material. The moving core 31 is received on the inner circumference side of the magnetic pipe 11 and the nonmagnetic pipe 13. The needle 15 is supported by and fixed to an inner circumference side of the moving core 31 by welding or the like. Accordingly, the needle 15 and the moving core 31 reciprocate together in the axial direction of the injector. The moving core 31 is connected with a spring 35. An end portion of the spring 35 on the one side in its axial direction is connected with the moving core 31, and an end portion of the spring 35 on the other side is connected to an adjusting pipe 36. The spring 35 urges the needle 15 via the moving core 31 in a direction in which the needle 15 is pressed against the valve seat of the valve body 14. The adjusting pipe 36 is supported by and fixed to an inner circumference side of the stator core 32. An axial direction hole 37 through which the fuel passage 18 and the fuel passage 21 communicate is formed in the adjusting pipe 36.

The stator core 32, the yoke 33, and the magnetic member 34 are integrally formed from a magnetic material. The stator core 32 is supported by and fixed to an inner circumference side of the coil system via the magnetic pipe 12. The stator core 32 is opposed to the moving core 31 a predetermined clearance therebetween. The clearance formed between this moving core 31 and stator core 32 corresponds to a lift amount of the needle 15. A spring receiving chamber 39 in which the spring 35 is received is formed in the stator core 32.

Next, the coil system of the injector includes a coil component (coil assembly: bobbin 1, coil 2, coil terminal 4) and the mold resin 6. The bobbin 1 is integrally formed from a resin material. The bobbin 1 is a resin part (primary mold goods), and a rectangular conductive wire (rectangular ribbon wire)covered with a dielectric film is wound multiple-times on an outer circumference of its cylindrical portion 43 and between its pair of collar-like parts 41, 42. A terminal guide 44 having an arc-shaped cross sectional surface and guiding the pair of coil terminals 4 extends upward in FIGS. 1A, 2 from one collar-like part 42 of the bobbin 1. One collar-like part 42 of the bobbin 1 has a locking groove 45 and two locking grooves 47. The locking groove 45 catches a coil-side end portion of the coil lead wire 3 on the negative electrode side pulled out from the initial winding end segment of the coil 2. The two locking grooves 47 catch intermediate parts of the pair of coil lead wires 3 pulled out from the initial winding end segment and terminal winding end segment of the coil 2, such that the ends of the pair of coil lead wires 3 are easily sent straightly toward each lead wire bundling part 46 of the pair of coil terminals 4.

The coil 2 is formed as a result of winding multiple-times a rectangular conductive wire covered with a dielectric film between the pair of collar-like parts 41, 42 of a pair and on the outer circumference of the cylindrical portion 43 is carried out. The initial winding end segment of the rectangular conductive wire of the coil 2 is wound around the collar-like part 42 of the bobbin 1, and then the rectangular conductive wire is wound on the outer circumference of the cylindrical portion 43 of the bobbin 1 by one layer. After that, the rectangular conductive wire is wound turning back to the collar-like part 42, and thereby a two-layer winding wire is formed. Alternatively, by repeating the above-mentioned process, a four-layer winding wire is formed on the outer circumference of the cylindrical portion 43 of the bobbin 1. The coil 2 is an exciting coil (solenoid coil) which generates magnetic attraction force (magnetomotive force) when driving power is supplied to the coil, and when the coil 2 is energized, it generates magnetic flux around. Accordingly, the moving core 31, the stator core 32, the yoke 33, and the magnetic member 34 are magnetized, and thereby the moving core 31 is attracted to the attracting part of the stator core 32 to be lifted (displaced) in a stroke direction. The collar-like parts 41, 42 and the cylindrical portion 43 of the bobbin 1 and coil 2 are disposed in a cylindrical space (coil receiving space) formed between the magnetic pipe 12 and the nonmagnetic pipe 13, and the yoke 33.

The coil 2 has a two-layer or four-layer coil part (winding portion) wound around the bobbin 1, and the pair of coil lead wires 3 taken out from the initial winding end segment and terminal winding end segment of the coil part. An end portion (hereinafter referred to as a lead wire end) 49 of each coil lead wire 3 is electrically connected to each fusing part 5 of the pair of coil terminals 4 by fusing joining (fusing connection). Each coil lead wire 3 has first and second planar fusing surfaces (joint surface) 51, 52 of plane shape, respectively on both sides of a lead wire end 49 of the coil lead wire 3 in its thickness direction (direction perpendicular to a direction in which the lead wire end 49 passes through the fusing part 5). Energization of the coil 2 is controlled by an engine control unit (hereinafter referred to as an ECU).

Each coil terminal 4 is formed in a predetermined shape by press punching a thin tabular metal plate. As shown in FIG. 1A, each coil terminal 4 has a thin tabular terminal body 53 extending along the axial direction of the bobbin 1 and the coil 2 toward a connector shell-side from a coil-side, and a thin tabular lead wire connection part 54 extending to respectively project from the terminal body 53 in a horizontal direction which is perpendicular to the axial direction in FIG. 1A.

Each terminal body 53 of the pair of coil terminals 4 has two flections 55, 56 to make a level difference in the body 53. An end portion of each terminal body 53 on an opposite side of the coil-side the point is exposed in a rectangular pipe-shaped connector shell (male connector) 7 formed integrally with the mold resin 6, and functions as a connector pin which is inserted in the female connector on an external power-side or on an injector drive circuit-side and on the GND side to made an electric connection.

Each lead wire connection part 54 of the pair of coil terminals 4 has a fusing part 5, the lead wire bundle part 46, and a protruding portion (conductive wire direction change section) 57, which are formed integrally with the connection part 54. The fusing part 5 has a U-shaped cross-sectional surface. The lead wire bundling part 46 bundles the intermediate part of each coil lead wire 3 by winding an arbitrary predetermined number of times the intermediate part pulled out from the bobbin 1 and the coil 2 around the lead wire bundle part 46. The protruding portion 57 converts a drawing direction of the lead wire end 49 of each coil lead wire 3 by hooking the lead wire end 49 of each coil lead wire 3 on the protruding portion 57, such that the lead wire end 49 of each coil lead wire 3 hooked on the lead wire bundling part 46 is easily sent (conducted) straightly toward the corresponding fusing part 5. In addition, a discarded wound portion of each coil lead wire 3 may be idly wound by winding an arbitrary predetermined number of times a discarded wound portion of each coil lead wire 3 pulled out from the bobbin 1 and the coil 2 around the lead wire bundle part 46 of each lead wire connection part 54.

As shown in FIGS. 1A to 1D and 3A to 4B, each fusing part 5 has a first planar part 61 and a folded piece 63. The first planar part 61 has a tabular shape and is in contact with a first fusing surface (one surface of the lead wire end 49 in its thickness direction, or one end surface) 51 of each lead wire end 49 of the pair of coil lead wires 3. The folded piece 63 includes a second planar part 62 having a tabular shape and opposed to the first planar part 61. The folded piece 63 projects from an end portion (upper end marginal part of the lead wire connection part 54 on its upper end side in FIG. 1B) of the first planar part 61, and is bent in the shape of a U character with an end of the first planar part 61 as the starting point such that each lead wire end 49 of the pair of coil lead wires 3 is placed between the folded piece 63 and the first planar parts 61.

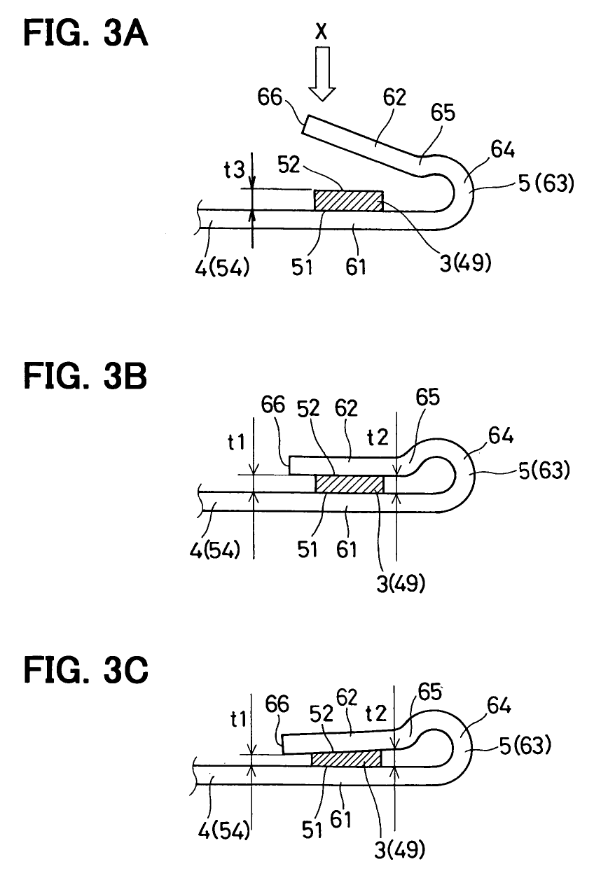

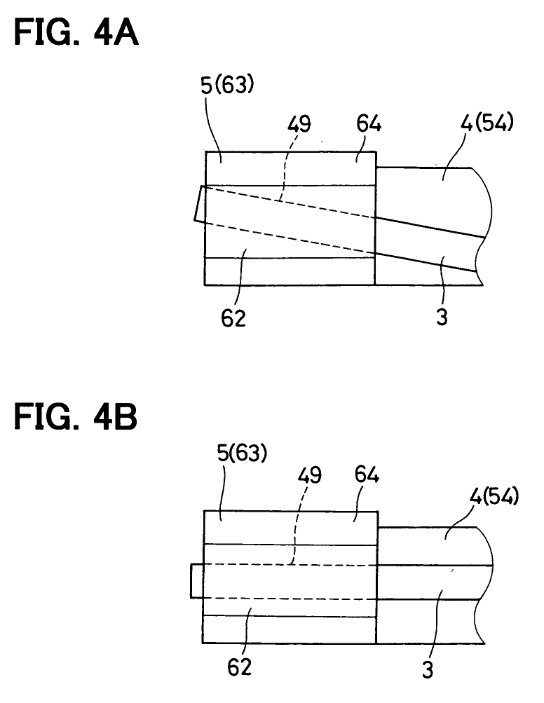

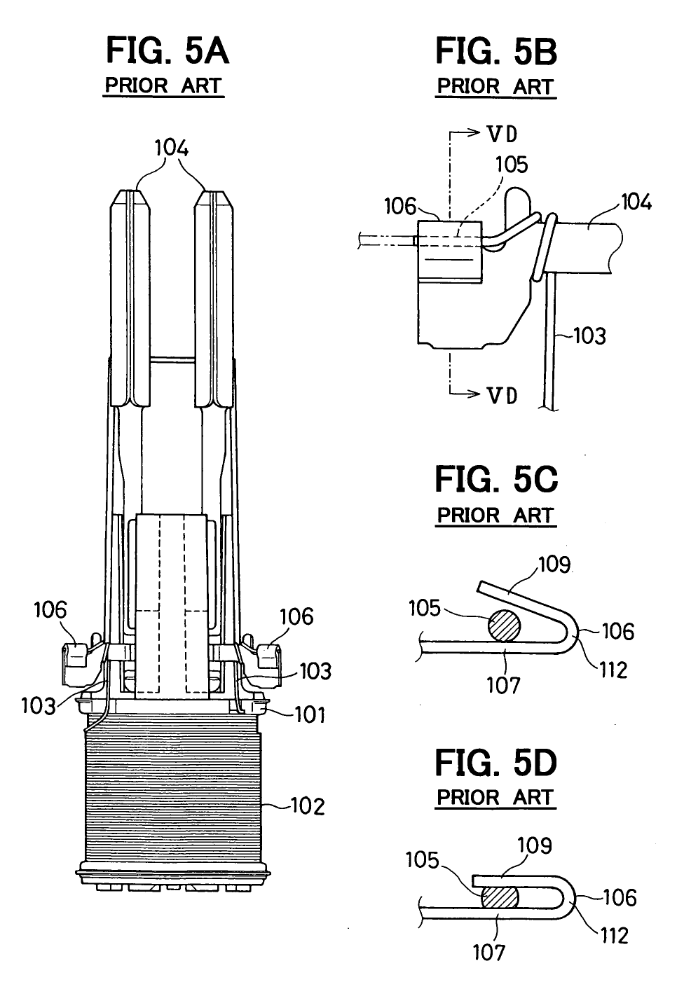

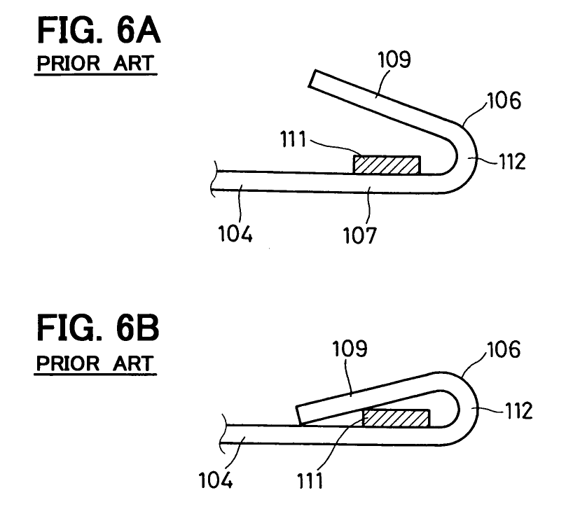

The folded piece 63 is bent in the shape of a U character in the thickness direction of the first planar part 61 to turn back from the end of the first planar part 61. The folded piece 63 has the second planar part 62 and the bent part 64. Each lead wire end 49 of the pair of coil lead wires 3 between the first planar parts 61 and the second planar part 62 to obtain a predetermined crushing allowance over the whole width and the whole length of the lead wire end 49. The bent part 64 connects the end of the first planar parts 61 and that of the second planar part 62, and has a larger curvature radius R than the thickness of the lead wire end 49 of each coil lead wire 3. Accordingly, the lead wire end 49 of each coil lead wire 3 is placed in the condition of having been crushed between the first and second planar parts 61, 62, as shown in FIGS. 3A to 3C and 4B. Alternatively, as shown in FIG. 4A, the lead wire end 49 of each coil lead wire 3 may be placed to be inclined with respect to a direction in which the folded piece 63 is bent over with the end of the first planar part 61 as the starting point.

The mold resin 6 corresponds to a dielectric resin of the invention, and is integrally formed from a dielectric resin material. The mold resin 6 covers and protects the coil component (the bobbin 1, the coil 2, the coil lead wire 3, and the coil terminal 4) of the coil system. The connector shell 7 is formed integrally with the mold resin 6. In other words, the bobbin 1, the coil 2, the pair of coil lead wires 3, and the pair of coil terminals 4 are molded into the injector of the present embodiment using the dielectric mold resin 6. In addition, a connection part (fusing connection) of each lead wire end 49 of the pair of coil lead wires 3 and the corresponding fusing part 5 may be molded with the mold resin 6.

### Fusing Connection Method of the Embodiment

Next, a fusing connection method of connecting the coil lead wire and the terminal of the present embodiment is briefly explained with reference to FIGS. 1A to 4B. The pair of coil lead wires 3 taken out from the initial winding end segment and terminal winding end segment of the coil 2 is first pulled out toward the respective lead wire bundle parts 46 of the pair of coil terminals 4 through the locking groove 45 and the two locking grooves 47 formed at the collar-like part 42 of the bobbin 1. Then, and the pair of coil lead wires 3 pulled out toward the respective lead wire bundle parts 46 is hooked on the respective protruding portions 57 after their intermediate parts are wound (bundled) around the corresponding lead wire bundle parts 46 by an arbitrary predetermined number of times. Meanwhile, the pair of coil lead wires 3 hooked around the respective protruding portions 57 have directions of their lead wire ends 49 converted at the protruding portions 57 such that their lead wire ends 49 are pulled out straightly from the corresponding protruding portions 57 toward fusing parts 5.

Each lead wire end 49 of the pair of coil lead wires 3 is inserted between the corresponding first planar part 61 and second planar part 62 of the folded piece 63. Meanwhile, as shown in FIGS. 1C, 3A, the lead wire end 49 is pulled such that the whole plate width and length of its first fusing side 51 are in contact with the first planar part 61. In other words, predetermined tension is given to the lead wire end 49.

By calking the second planar part 62 of the folded piece 63 using a punch and then energizing a pair of fusing electrodes with the fusing electrodes attached on and pressurizing both sides of the whole fusing part 5 in its thickness direction, the dielectric film given to each lead wire end 49 is exfoliated, and thereby an electric connection is made in the connection part between the lead wire end 49 and the fusing part 5. Meanwhile, each lead wire end 49 of the pair of coil lead wires 3 is placed in the condition of having been crushed to have a predetermined crushing allowance between the first and second planar parts 61, 62, as shown in FIGS. 3B, 3C.

When fusing surface thicknesses of the lead wire end 49 (rectangular conductive wire) of the coil lead wire 3 after fusing joining are set to be t1, t2 and an initial fusing surface thickness of the lead wire end 49 is set to be t3, the lead wire end 49 is inserted and crushed (pressurized) between the first and second planar parts 61, 62 to satisfy the following operation expression 1 or 2.

t1=t2<t3 (expression 1)

t1<t2<t3 (expression 2)

In addition, t1 is a fusing surface thickness on a side of the end of each folded piece 63 (second planar part 62) of the pair of coil terminals 4 after fusing joining, and t2 is a fusing surface thickness on a side of the bent part of the folded piece 63 after fusing joining.

The second planar part 62 shown in FIG. 3B extends straightly in a direction from the end portion (flection 65 of the folded piece 63) of the coil terminal 4 on the first planar part-side toward the end portion (free end section 66 of the folded piece 63) of the coil terminal 4 on the opposite side of the first planar part to be parallel to the plane direction of the first and second fusing surfaces 51, 52 of the lead wire end 49, to obtain the predetermined crushing allowance (t3−t1, t3−t2) defined by the expression 1 when the lead wire end 49 of the coil lead wire 3 is placed between the first and second planar parts 61, 62. The second planar part 62 shown in FIG. 3C extends straightly in a direction from the flection 65 of the folded piece 63 toward the free end section 66 of the folded piece 63 to be inclined with respect to the plane direction of the first and second fusing surfaces 51, 52, to obtain the predetermined crushing allowance (t3−t1, t3−t2) defined by the expression 2 when the lead wire end 49 of the coil lead wire 3 is placed between the first and second planar parts 61, 62.

### Workings of the Embodiment

Next, workings of the injector of the present embodiment are briefly explained with reference to FIGS. 1A to 2. When the coil 2 of the valve drive unit of the injector is energized, magnetomotive force is generated in the coil 2, and thereby the magnetic materials of the moving core 31, the stator core 32, the yoke 33, and the magnetic member 34 are magnetized. Accordingly, magnetic attraction force is generated between the moving core 31 and the stator core 32. As a result, the moving core 31 is attracted to the attracting part of the stator core 32 to be displaced toward one side (upper side in FIG. 2) of the moving core 31 in its axial direction. When the moving core 31 is displaced toward its one side, the needle 15, which is arranged coaxially with the moving core 31 and supported by and fixed to the moving core 31, is also displaced toward the one side. Thus, a seat portion of the needle 15 disengages from the valve seat of the valve body 14 to open the plurality of nozzle holes formed on the nozzle hole plate 19.

Fuel which flows into the injector through the fuel inlet 16 flows into the fuel passage 20 between the inner circumference of the valve body 14 and the outer circumference of the needle 15 via the fuel filter 17, the fuel passage 18 in the magnetic pipe 12, the axial direction hole 37 in the adjusting pipe 36, the fuel passage 21 in the needle 15, and the fuel hole 22 of the needle 15. Fuel which has flowed into the fuel passage 20 flows into the plurality of nozzle holes via between the needle 15 that has disengaged from the valve seat and the valve body 14. Therefore, fuel is injected through the plurality of nozzle holes.

When the energization of the coil 2 is stopped, the magnetic attraction force between the moving core 31 and the stator core 32 ceases to exist. Accordingly, the needle 15 and the moving core 31 are pressed on the valve seat of the valve body 14 by the urging force (spring load) of the spring 35. Thus, the sealing part of the needle 15 engages the valve seat of the valve body 14 to close the plurality of nozzle holes. Therefore, the injection of fuel is ended.

### Effects of the Embodiment

As mentioned above, in the terminal structure of the coil system of the present embodiment, by forming the second planar part 62 on the folded piece 63 of the coil terminal 4 to placing each lead wire end 49 of the pair of coil lead wires 3 between the first planar part 61 and the second planar part 62, the lead wire end 49 is placed and crushed between the first and second planar parts 61, 62.

Therefore, at the time of fusing joining (at the time of fusing treatment), that is, when the second planar part 62 of the folded piece 63 is calked by the punch, and then, the pair of fusing electrodes is attached on both sides of the whole fusing part 5 in its thickness direction to be energized with the fusing part 5 pressurized, the first and second fusing surfaces 51, 52 of the lead wire end 49 are crushed such that the predetermined crushing allowance of the lead wire end 49 is obtained over its whole width and length between the first and second planar parts 61, 62 of the coil terminal 4.

When the fusing electrodes are energized at the time of the fusing joining, a current flows through the lead wire end 49 of the coil lead wire 3 evenly over its whole plate width and length in a direction perpendicular to the plane direction of the first fusing surface 51, and the dielectric film exfoliates efficiently from the surfaces (first and second fusing surfaces 51, 52) of the lead wire end 49, so that the conductive part of the rectangular conductive wire is exposed. For this reason, the stable continuity (electric connection) is achieved in the connection part of the coil lead wire 3 made of the rectangular conductive wire having a quadrangular cross-sectional surface and the terminal 4. Therefore, a faulty connection of the coil lead wire 3 and the terminal 4 is eliminated, and thereby reliability over the electric continuity in the fusing connection is improved. In addition, the terminal structure of the invention is the most effective for the coil lead wire 3 having a ratio of 1:3 between a size of the lead wire end 49 (rectangular conductive wire) in its thickness direction and a size of the lead wire end 49 in its width direction.

When the second planar part 62 shown in FIGS. 1D, 3B extending straightly in the direction from the flection 65 toward the free end section 66 of the folded piece 63 to be parallel to the plane direction of the first and second fusing surfaces 51, 52 of the lead wire end 49 of the coil lead wire 3 is employed as the second planar part 62 of the coil terminal 4, respective joint surfaces between the first and second fusing surfaces 51, 52 and the first and second planar parts 61, 62 of the coil terminal 4 are made large. Meanwhile, the lead wire end 49 of the coil lead wire 3 is placed between the first and second planar parts 61, 62 with the lead wire end 49 crushed in its thickness direction by the predetermined crushing allowance.

When the fusing electrodes are energized at the time of the fusing joining, a current flows through the lead wire end 49 of the coil lead wire 3 evenly over its whole plate width and length in a direction perpendicular to the plane direction of the first fusing surface 51, wince a clearance is not formed between the second fusing surface 52 of the lead wire end 49 and a contact surface of the second planar part 62. Accordingly, a dielectric film exfoliates efficiently from the surfaces (first, second fusing surfaces 51, 52) of the lead wire end 49, and the conductive part of the rectangular conductive wire is exposed. Also, the joint surface of the conductive part of the rectangular conductive wire and the first and second planar parts 61, 62 of the coil terminal 4, that is, an area of the connection part (fusing connection) of the exposed part of the conductive part of the coil lead wire 3 and the coil terminal 4 becomes large, and thereby the stable electric continuity is achieved.

When the second planar part 62 shown in FIG. 3C extending straightly in the direction from the flection 65 toward the free end section 66 of the folded piece 63, being inclined with respect to the plane direction of the first and second fusing surfaces 51, 52 of the lead wire end 49 of the coil lead wire 3, is employed as the second planar part of the coil terminal 4 in order that the predetermined crushing allowance indicated by the expression 2 is obtained when the lead wire end 49 is placed between the first and second planar parts 61, 62, the joint surface of the first and second fusing surfaces 51, 52 and the first and second planar parts 61, 62 of the coil terminal 4 becomes still larger compared with the embodiment shown in FIGS. 1D, 3B. Meanwhile, the lead wire end 49 of the coil lead wire 3 is placed between the first and second planar parts 61, 62 with the lead wire end 49 crushed in its thickness direction by the predetermined crushing allowance.

When the fusing electrodes are energized at the time of the fusing joining, a current flows through the lead wire end 49 of the coil lead wire 3 evenly over its whole plate width and length in a direction perpendicular to the plane direction of the first fusing surface 51, since a clearance is not formed between the second fusing surface 52 of the lead wire end 49 of the coil lead wire 3 and a contact surface of the second planar part 62. Accordingly, a dielectric film exfoliates efficiently from the surfaces (first, second fusing surfaces 51, 52) of the lead wire end 49, and the conductive part of a rectangular conductive wire is exposed. Also, the joint surface of the conductive part of the rectangular conductive wire and the first and second planar parts 61, 62 of the coil terminal 4, that is, an area of the connection part (fusing connection) of the exposed part of the conductive part of the coil lead wire 3 and the coil terminal 4 becomes even larger compared with the embodiment shown in FIGS. 1D, 3B, and thereby the stable electric continuity is achieved.

As shown in FIG. 4B, in the terminal structure of the coil system of the present embodiment, the lead wire end 49 of the coil lead wire 3 is passed between the first and second planar parts 61, 62, extending straightly in the direction perpendicular to the direction (vertical direction in FIG. 4B) in which the folded piece 63 is bent over with the end of the first planar part 61 as the starting point, and then, a surplus wire of the lead wire end 49 is cut off with a predetermined surplus allowance left after the fusing joining. Alternatively, as shown in FIG. 4A, the lead wire end 49 may be passed to be inclined with respect to the direction in which the folded piece 63 is bent over with the end of the first planar part 61 as the starting point by a predetermined angle.

In this case, the joint surface of the lead wire end 49 and the first and second planar parts 61, 62 becomes still larger. As mentioned above, the lead wire end 49 is inserted between the first and second planar parts 61, 62, being crushed in its thickness direction by the predetermined crushing allowance.

Since a clearance is not formed between the second fusing surface 52 of the lead wire end 49 and the contact surface of the second planar part 62 when the fusing electrodes are energized at the time of fusing joining, a current flows through the lead wire end 49 evenly over its whole plate width and length in the direction perpendicular to the plane direction of the first fusing surface 51. Accordingly, a dielectric film exfoliates efficiently from the surfaces (first, second fusing surfaces 51, 52) of the lead wire end 49, and the conductive part of a rectangular conductive wire is exposed. In addition, a joint surface of the conductive part of the rectangular conductive wire and the first and second planar parts 61, 62, that is, an area of the connection part of the exposed part of the conductive part of the coil lead wire 3 and the coil terminal 4 becomes still larger compared with the embodiment shown in FIGS. 1D, 3B, and thereby the stable continuity is achieved.

In the terminal structure of the coil system of the present embodiment, as shown in FIG. 2, the connection part (fusing connection) of the lead wire end 49 of the coil lead wire 3 and the first and second planar parts 61, 62 of the coil terminal 4 is treated with molding with the dielectric mold resin 6.

In a case where the fusing part 5 at which the fusing connection is made on the lead wire end 49 of the coil lead wire 3 made of the rectangular conductive wire having a quadrangular cross-sectional surface and picked out from the coil 2 is received in the mold resin 6, when a temperature change, that is, a cold and hot cycle is repeated (e.g., engine room temperature varies between about −30° C. and +120° C. by according to stop and operation of an engine), a contact portion of the coil terminal 4 and the mold resin 6 may exfoliate, since a coefficients of linear expansion of the coil terminal 3 made of metal and that of the mold resin 6 made of resin differ. When the contact portion of the coil terminal 4 and the mold resin 6 exfoliates, a stress concentrates on the perimeter of the exfoliation portion, and thereby a crack which is a dielectric lacking part is easily generated in the mold resin 6. Moreover, if the crack is generated, the lead wire end 49 of the coil lead wire 3 easily disengages from the fusing part 5 of the coil terminal 4.

In the terminal structure of the coil system of the present embodiment, by forming the second planar part 62 on the folded piece 63 of each fusing part 5 of the pair of coil terminals 4 so that the lead wire end 49 of the corresponding coil lead wire 3 is placed between the first planar part 61 and the second planar part 62 to obtain the predetermined crushing allowance over the whole plate width and length of the lead wire end 49, the prevention of the separation of the coil lead wire 3 from the fusing part 5 is promoted. Accordingly, even if the crack is generated, malfunctions such as the separation of the coil lead wire 3 from the fusing part 5 are restricted. In addition, in the present embodiment, the terminal structure of the invention is applied to both the coil terminals 4 on the positive and negative sides. Alternatively, the terminal structure may be applied to only one of the coil terminal 4 on the positive side and the coil terminal 4 on the negative side.

### (Modifications)

The present embodiment is applied to the injector which injects fuel into suction air suctioned into the combustion chamber of the gasoline engine as a fuel injection valve for the internal combustion engine. Alternatively, the present embodiment may be applied to a direct-injection fuel injector which injects fuel directly into the combustion chamber of the gasoline engine or to an injector for a diesel engine as the fuel injection valve for the internal combustion engine. In the present embodiment, the fuel injection valve for the internal combustion engine such as the injector (fuel injector) is attached to the intake manifold of the gasoline engine. Alternatively, the fuel injection valve may be attached to a cylinder of the engine.

In the present embodiment, the invention is applied to the injector in which the needle 15 constituting the valve element of the fuel injection nozzle reciprocates in its axial direction using the electromagnetic actuator. Alternatively, the invention may be applied to a fuel injection valve, in which the valve element mechanically reciprocates in its axial direction. For example, the invention may be applied to a fuel injection nozzle, in which the valve element opens when fuel is supplied into a valve body to have a predetermined hydraulic pressure. In the present embodiment, the rectangular conductor (e.g., copper wire), to which the dielectric film is applied, is employed as the rectangular conductive wire having a square cross-sectional surface. Alternatively, a rectangular enameled wire formed as a result of burning a coating or resin (polyester resin, silicone resin, or tetrafluoroethylene resin) into the surface of the rectangular conductor to be a dielectric film may be employed as the rectangular conductive wire having a square cross-sectional surface. In addition, an enamel copper wire, formal copper wire, polyester copper wire, or polyurethane copper wire may be used as the rectangular enameled wire.

In the present embodiment, the electromagnetic actuator (electromagnetic drive part) equipped with the electromagnet including the coil system (the rotor coil and armature coil) is used for the valve drive unit which drives the needle (movable body) 15 of the injector. Alternatively, an electromotive actuator equipped with an electric motor having a coil system may be used as the valve drive unit which drives the valve of the fluid-controlled valve. Moreover, the terminal structure of the coil system of the invention may be applied not only to the fuel injection valve but to a fluid passage opening and closing valve, fluid passage shutoff valve, fluid flow control valve, or fluid-pressure control valve as the fluid-controlled valve. Also, not only fuel but gases such as air and evaporated fuel, or liquids such as water and oil may be used as the fluid. The coil may be incorporated in a motor drive unit for driving a motor.

In the present embodiment, the bent part 64 having a larger curvature radius R than the thickness of the lead wire end 49 of each coil lead wire 3 is formed between the end of the first planar part 61 and the end of the second planar part 62. Alternatively, a bent part having a smaller curvature radius R than the thickness of the lead wire end 49 of each coil lead wire 3 may be formed between the end of the first planar part 61 and the end of the second planar part 62. In addition, a flection crooked in a V-shaped or horseshoe-shaped manner may be formed as a link part connecting the end of the first planar part 61 and the end of the second planar part 62.

Additional advantages and modifications will readily occur to those skilled in the art. The invention in its broader terms is therefore not limited to the specific details, representative apparatus, and illustrative examples shown and described.

What is claimed is:

1. A terminal structure of a coil system, comprising:
a coil that includes:
a rectangular conductive wire having a quadrangular cross-sectional surface and covered with a dielectric film; and
a bobbin, around which the rectangular conductive wire is wound, wherein the rectangular conductive wire includes a coil lead wire, which is taken out from the coil; and
a terminal having a fusing portion, which is electrically connected by fusing to an end portion of the coil lead wire, wherein:
the fusing portion includes a first planar portion having a plate-like shape and in contact with a surface of the end portion of the coil lead wire;
the fusing portion is folded from the first planar portion in a thickness direction of the first planar portion so as to form a folded piece opposed to the first planar portion;
the folded piece has a second planar portion; and
the end portion of the coil lead wire is placed between the first planar portion and the second planar portion such that a predetermined crushing allowance of the end portion is crushed entirely in a width direction of the end portion.

2. The terminal structure according to claim 1, wherein:
the folded piece projects from an end portion of the first planar portion, at which the fusing portion is folded; and
the fusing portion is folded in a shape of one of letters U, V and squared U from the end portion of the first planar portion so as to form the folded piece, such that the end portion of the coil lead wire is placed between the folded piece and the first planar portion.

3. The terminal structure according to claim 1, wherein:
the coil lead wire includes two joint surfaces, each of which has a planar shape, on both sides of the end portion in a thickness direction thereof, respectively;
the second planar portion extends straightly in a direction from an end portion of the terminal, at which the fusing portion is folded from the first planar portion, toward a free end portion of the terminal opposed to the first planar portion; and
the direction from the end portion toward the free end portion of the terminal is parallel to respective planar directions of the two joint surfaces.

4. The terminal structure according to claim 1, wherein:
the coil lead wire includes two joint surfaces, each of which has a planar shape, on both sides of the end portion in a thickness direction thereof, respectively;
the second planar portion extends straightly in a direction from an end portion of the terminal, at which the fusing portion is folded from the first planar portion, toward a free end portion of the terminal opposed to the first planar portion; and
the direction from the end portion toward the free end portion of the terminal is inclined in relation to a planar direction of one of the two joint surfaces in contact with the first planar portion.

5. The terminal structure according to claim 1, wherein the end portion of the coil lead wire is placed between the first planar portion and the second planar portion, and extends between the first planar portion and the folded piece.

6. The terminal structure according to claim 1, wherein the end portion of the coil lead wire extends in a direction that is inclined with respect to such a direction in which the fusing portion is folded to form the folded piece with an end portion of the first planar portion being a starting point of the folding.

7. The terminal structure according to claim 1, wherein a connection part of the end portion of the coil lead wire and the fusing portion is treated with molding using a dielectric resin.

8. The terminal structure according to claim 1, wherein the coil is incorporated in a drive unit for driving a movable body.
